(19) United States
(12) Patent Application Publication
(10) Pub. No.: US 2023/0303047 A1
(43) Pub. Date: Sep. 28, 2023

(54) ELECTRIC BRAKE SYSTEM AND CONTROL METHOD THEREOF

(71) Applicant: HL MANDO CORPORATION, Pyeongtaek-si (KR)

(72) Inventor: Seungkuk LIM, Seoul (KR)

(21) Appl. No.: 18/125,222

(22) Filed: Mar. 23, 2023

(30) Foreign Application Priority Data
Mar. 24, 2022 (KR) 10-2022-0036915

(51) Int. Cl. B60T 13/68; B60T 13/74

(52) U.S. Cl. CPC B60T 13/686; B60T 13/745

(57) ABSTRACT

Disclosed herein is an electric brake system including a hydraulic circuit configured to guide a pressurizing medium to a wheel cylinder, a plurality of electronic valves configured to open or close a flow path of the hydraulic circuit, and a controller electrically connected to the plurality of electronic valves. The controller includes a first processor configured to control the plurality of electronic valves and a second processor configured to control the plurality of electronic valves based on state information received from the first processor. While the first processor maintains the opening or closing of at least one electronic valve, the second processor is configured to provide an electrical signal to open an opened at least one electronic valve or an electrical signal to close a closed at least one electronic valve based on the state information received from the first processor.

### CROSS-REFERENCE TO RELATED APPLICATION

This application claims the benefit of Korean Patent Application No. 10-2022-0036915, filed on Mar. 24, 2022 in the Korean Intellectual Property Office, the disclosure of which is incorporated herein by reference.

### BACKGROUND

### 1. Field

Embodiments of the present disclosure relate to an electric brake system and a control method thereof.

### 2. Description of the Related Art

Generally, as part of the ongoing demand for environmental friendliness and safety, and emergency braking and preparation for autonomous driving, a brake-by-wire system which replaces a mechanical connection between a master cylinder, a booster, an anti-lock brake system (ABS), and an electronic stability control (ESC) device with an electrical and electronic connection to achieve electricalization is being developed. In particular, an integrated electric brake system in which, when an electrical signal corresponding to a braking intent of a driver is detected through a brake pedal displacement sensor for detecting a displacement of a brake pedal, a controller operates a motor to move a piston in a pressure chamber so that a hydraulic pressure supply device for generating a hydraulic pressure required for braking is driven to generate a braking force is being applied.

In the electric brake system, a controller should control the motors and valves of the system in order to generate a braking force. However, when the controller fails, the motors and valves cannot be operated so that it is difficult to secure the safety of the system.

Conventionally, even when a failure occurs in a controller, a pair of controllers for performing the same function are provided to be able to replace a function of the malfunctioning controller in real time, and an auxiliary controller replaces a main controller to operate when the main controller fails. Thus, even when the main controller fails, redundancy can be secured so that the safety of a system can be improved.

However, conventionally, when the main controller fails, an instantaneous current drop occurs in a process of switching a current supplied to a coil of a valve installed in the system during a controller transition process from the main controller to the auxiliary controller. In this case, since the current drops to a cut-out current or less, which is a release current of a valve in operation, the operation of the valve is stopped, and thus normal pressure control may not be performed.

### SUMMARY

Therefore, it is an aspect of the present disclosure to provide an electric brake system and a control method thereof, which are capable of stably securing braking performance by ensuring the operational stability of an electronic valve even when an instantaneous current drop occurs in an electronic valve in operation while a malfunctioning controller is changed to a normal controller when the controller in operation fails.

Additional aspects of the present disclosure will be set forth in part in the description which follows and, in part, will be obvious from the description, or may be learned by practice of the disclosure.

In accordance with one aspect of the present disclosure, an electric brake system includes a hydraulic circuit configured to guide a pressurizing medium to a wheel cylinder, a plurality of electronic valves configured to open or close a flow path of the hydraulic circuit, and a controller electrically connected to the plurality of electronic valves. The controller may include a first processor configured to control the plurality of electronic valves and a second processor configured to control the plurality of electronic valves based on state information received from the first processor. While the first processor maintains the opening or closing of at least one electronic valve among the plurality of electronic valves, the second processor is configured to provide an electrical signal to open an opened at least one electronic valve or an electrical signal to close a closed at least one electronic valve based on the state information received from the first processor.

The second processor may correct a target current of the at least one electronic valve and increase a driving current supplied to the at least one electronic valve to allow the driving current of the at least one electronic valve to reach the corrected target current.

The second processor may increase the target current of the at least one electronic valve to a maximum current which secures operability within a pressure range secured by the at least one electronic valve.

The second processor is configured to maintain the maximum current for a predetermined period of time and then reduces the maximum current to a hold current for maintaining an on state of the at least one electronic valve, based on a driving current reaching the maximum current.

The second processor may increase the target current of the at least one electronic valve to a current that is greater than a cut-in current for switching a state of the at least one electronic valve from an off state to an on state.

In accordance with another aspect of the present disclosure, an electric brake system includes a reservoir configured to store a pressurizing medium, a hydraulic pressure supply device configured to operate a hydraulic piston by a motor and generate a hydraulic pressure of the pressurizing medium, a hydraulic pressure controller including a plurality of electronic valves and configured to control a flow of the pressurizing medium transmitted from the hydraulic pressure supply device to a wheel cylinder, and a controller electrically connected to the motor and the plurality of electronic valves. The controller may include a first processor configured to control the plurality of electronic valves and a second processor configured to control the plurality of electronic valves based on state information received from the first processor. While the first processor maintains the opening or closing of at least one electronic valve among the plurality of electronic valves, the second processor is configured to provide an electrical signal to open an opened at least one electronic valve or an electrical signal to close a closed at least one electronic valve based on the state information received from the first processor.

The second processor may correct a target current of the at least one electronic valve and increase a driving current supplied to the at least one electronic valve to allow the driving current of the at least one electronic valve to reach the corrected target current.

The second processor may increase a driving current of the at least one electronic valve to a maximum current which secures operability within a pressure range secured by the at least one electronic valve.

The second processor maintains the maximum current for a predetermined period of time and then reduces the maximum current to a hold current for maintaining an on state of the at least one electronic valve based on a driving current reaching the maximum current.

The second processor may increase a target current to a cut-in current or more, which is to switch a state of the at least one electronic valve from an off state to an on state, and then decrease the target current to a hold current for maintaining the on state of the at least one electronic valve.

In accordance with one aspect of the present disclosure, a method of controlling an electric brake system, which includes a hydraulic circuit configured to guide a pressurizing medium to a wheel cylinder, a plurality of electronic valves configured to open or close a flow path of the hydraulic circuit, a first processor configured to control the plurality of electronic valves, and a second processor configured to control the plurality of electronic valves based on state information received from the first processor, includes: receiving, by the second processor, a state of the first processor while the first processor maintains the opening or closing of at least one electromagnetic valve; determining whether a failure occurs in the first processor according to the received state of the first processor; and providing, by the second processor, an electrical signal to open an opened at least one electronic valve or an electrical signal to close a closed at least one electronic valve based on the failure of the first processor.

The providing of the electrical signal may include correcting, by the second processor, a target current of the at least one electronic valve; and increasing a driving current supplied to the at least one electronic valve to allow the current of the at least one electronic valve to reach the corrected target current.

The correcting of the target current of the at least one electronic valve may include correcting, by the second processor, the target current of the at least one electronic valve to a maximum current which secures operability within a pressure range secured by the at least one electronic valve.

The increasing of the driving current supplied to the at least one electronic valve may include maintaining, by the second processor, the maximum current for a predetermined period of time and then reducing the maximum current to a hold current for maintaining an on state of the at least one electronic valve based on a driving current of the at least one electronic valve reaching the maximum current.

The correcting of the target current of the at least one electronic valve may include correcting, by the second processor, the target current of the at least one electronic valve to a current that is greater than a cut-in current for switching a state of the at least one electronic valve from an off state to an on state.

### BRIEF DESCRIPTION OF THE DRAWINGS

These and/or other aspects of the present disclosure will become apparent and more readily appreciated from the following description of the embodiments, taken in conjunction with the accompanying drawings of which:

FIG. 1 is a diagram illustrating a hydraulic circuit of an electric brake system according to one embodiment;

FIG. 2 is a diagram illustrating a normal operation of the electric brake system according to one embodiment;

FIG. 3 is a control block diagram of the electric brake system according to one embodiment;

FIG. 4 is a control block diagram of a first controller and a second controller of a controller of the electric brake system according to one embodiment;

FIG. 5 is a diagram illustrating a target current pattern of an electronic valve in the electric brake system according to one embodiment;

FIG. 6 is a diagram illustrating that a target current of the electronic valve is changed from a hold current to a maximum current and then changed to the hold current again when a malfunctioning controller is changed to a normal controller due to the failure of the controller in operation during braking control of the electric brake system according to one embodiment;

FIG. 7 is a diagram illustrating a valve operation release due to a current drop in the electronic valve occurring in a process of changing a malfunctioning first controller to a normal second controller during the braking control of the electric brake system according to one embodiment;

FIG. 8 is a diagram illustrating that the electronic valve is re-operated by re-applying an electronic valve current that is greater than or equal to a cut-in current in a process of changing the malfunctioning first controller to the normal second controller during the braking control of the electric brake system according to one embodiment; and

FIG. 9 is a control flowchart of an electric brake system according to one embodiment.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

Reference will now be made in detail to the exemplary embodiments of the present disclosure, examples of which are illustrated in the accompanying drawings, wherein like reference numerals refer to like elements throughout.

The expression, “at least one of a, b, and c,” should be understood as including only a, only b, only c, both a and b, both a and c, both b and c, or all of a, b, and c.

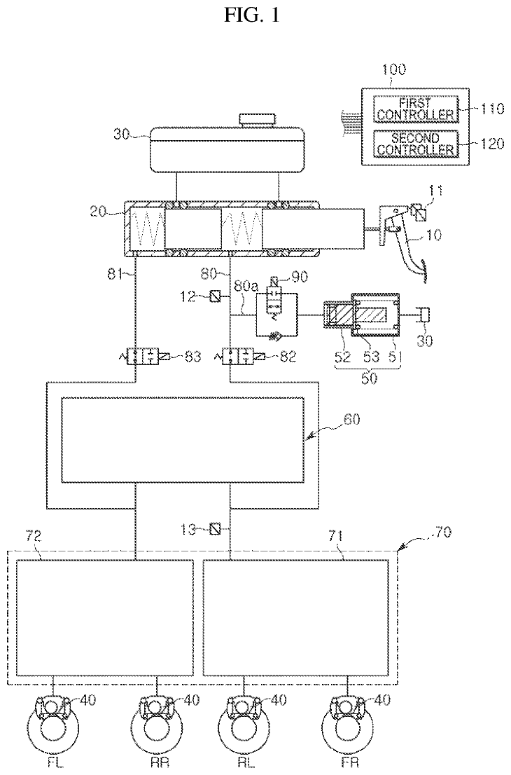

FIG. 1 is a diagram illustrating a hydraulic circuit of an electric brake system according to one embodiment.

Referring to FIG. 1, the electric brake system may include a master cylinder configured to pressurize and discharge a pressurizing medium accommodated therein in response to a manipulation of a brake pedal 10, a reservoir 30 coupled to an upper side of the master cylinder 20 and storing the pressurizing medium, wheel cylinders 40 provided at wheels RR, RL, FR, and FL, a pedal simulator 50 configured to provide a reaction force according to a pedal force of the brake pedal 10, a hydraulic pressure supply device 60 driven by an electrical signal corresponding to a movement of the brake pedal 10 and configured to generate hydraulic pressure to supply the generated hydraulic pressure to the wheel cylinders 40 provided at the wheels RR, RL, FR, and FL, a hydraulic pressure controller 70 configured to control the flow of the hydraulic pressure transmitted to each wheel cylinder 40 by the hydraulic pressure supply device 60, and a controller (electronic control unit (ECU)) 100 configured to control the hydraulic pressure supply device 60, the hydraulic pressure controller 70, and various valves based on hydraulic pressure information and pedal movement information.

The pedal simulator 50 may provide a reaction force against a pedal force of the brake pedal 10 on a branched flow path 80a which branches from a first backup flow path 80, which will be described below, to the reservoir 30. The pedal simulator 50 may include a simulation chamber 51 provided on the branched flow path 80a to store the pressurizing medium flowing out from the master cylinder 20, a reaction force piston 52 provided in the simulation chamber 51, and a reaction force spring 53 configured to elastically support the reaction force piston 52. The pedal simulator 50 may form a pressure in the simulation chamber 51 to provide an appropriate pedal feel to a driver.

The hydraulic pressure supply device 60 may be provided as a device through various methods and structures. As one example, in the hydraulic pressure supply device 60, a hydraulic piston driven by a driving force of a motor may push a pressurizing medium in a chamber to transmit a hydraulic pressure to the hydraulic pressure controller 70. In addition, the hydraulic pressure supply device 60 may be provided as a pump driven by a motor or a high-pressure accumulator. Specifically, as a displacement of the brake pedal 10 changes when a driver applies a pedal force to the brake pedal 10, an electrical signal is transmitted from a pedal displacement sensor 11, and the motor may be operated by the electrical signal. In addition, a power converter may be provided between the motor and the piston to convert the rotational movement of the motor into rectilinear movement. The power converter may include a worm and a worm gear and/or a rack and pinion gear.

The hydraulic pressure controller 70 may include at least one inlet valve and/or outlet valve for communicating or blocking between an internal flow path and a chamber divided by the hydraulic piston according to a braking mode.

The hydraulic pressure controller 70 may include a first hydraulic circuit 71 configured to receive a hydraulic pressure and control a hydraulic pressure transmitted to two wheel cylinders, and a second hydraulic circuit 72 configured to control a hydraulic pressure transmitted to the other two wheel cylinders. As one example, the first hydraulic circuit 71 may control a front right wheel FR and a rear left wheel RL, and the second hydraulic circuit 72 may control a front left wheel FL and a rear right wheel RR. However, the present disclosure is not limited thereto, and positions of the wheels connected to the first hydraulic circuit 71 and the second hydraulic circuit 72 may be configured in various ways.

The hydraulic pressure controller 70 may include an inlet valve provided at a front end of each wheel cylinder 40 and configured to control a hydraulic pressure, and an outlet valve branching off between the inlet valve and the wheel cylinder 40 and connected to the reservoir 30. The hydraulic pressure supply device 60 may be connected to a front end of the inlet valve of the first hydraulic circuit 71, and the hydraulic pressure supply device 60 may be connected to a front end of the inlet valve of the second hydraulic circuit 72. The hydraulic pressure generated and provided by the hydraulic pressure supply device 60 may be supplied to the first hydraulic circuit 71 and the second hydraulic circuit 72.

When the electric brake system cannot operate normally due to a failure of the hydraulic pressure supply device 60, backup flow paths 80 and 81 are flow paths used in a fallback mode in which the hydraulic pressure discharged from the master cylinder 20 is directly supplied to the hydraulic pressure controller 70 to implement braking of the wheel cylinder 40.

The backup flow paths 80 and 81 include a first backup flow path 80 connecting a first cylinder chamber of the master cylinder 20 to the first hydraulic circuit 71, and a second backup flow path 81 connecting a second cylinder chamber of the master cylinder 20 to the second hydraulic circuit 72.

A first cut valve 82 configured to control the flow of hydraulic pressure may be installed at the first backup flow path 80.

A second cut valve 83 configured to control the flow of hydraulic pressure may be installed at the second backup flow path 81.

The first cut valve 82 and the second cut valve 83 may each be a normally open type solenoid valve which is usually open and operates to be closed when a close signal from the controller 100 is received. In the case of reducing the number of valves to simplify a structure of the device, a cut valve may not be installed at least one of the first backup flow path 80 and the second backup flow path 81. Instead, the first backup flow path 80 and the outlet valve of the first hydraulic circuit 71 may be connected to allow the outlet valve provided in the first hydraulic circuit 71 to perform a function of a cut valve, or the second backup flow path 81 and the outlet valve of the second hydraulic circuit 72 may be connected to allow the outlet valve provided in the second hydraulic circuit 72 to perform a function of a cut valve.

A simulator valve 90 may be provided on the branched flow path 80a between the master cylinder 20 and the pedal simulator 50. The simulator valve 90 may open or close the branched flow path 80a between the master cylinder 20 and the pedal simulator 50. When the simulator valve 90 is opened, the hydraulic pressure generated by the master cylinder 20 may be transmitted to the pedal simulator 50. The simulator valve 90 may be a normal closed type solenoid valve which is usually closed and operates to be opened when an open signal from the controller 100 is received.

Reference numeral 12 denotes a pedal simulator pressure sensor configured to detect a pressure of the pedal simulator 50 and detects the hydraulic pressure transmitted from the master cylinder 20 to the pedal simulator 50. Since the pedal simulator pressure sensor 12 is provided on the first backup flow path 80 connected to the master cylinder 20, the pedal simulator pressure sensor 12 may detect a pressure of the master cylinder 20 and may be referred as a master cylinder pressure sensor. Reference numeral 13 may denote a circuit pressure sensor configured to detect the hydraulic pressure of the hydraulic circuits 71 and 72.

The controller 100 includes a first controller (a main controller) 110 and a second controller (an auxiliary controller) 120 as a pair which perform the same function in order to configure redundancy.

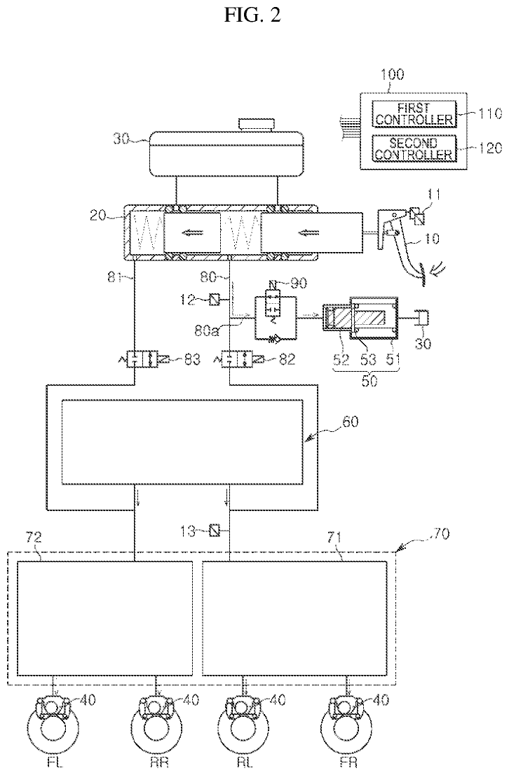

FIG. 2 is a diagram illustrating a normal operation of the electric brake system according to one embodiment.

Referring to FIG. 2, when the driver operates the brake pedal 10, the controller 100 may close the first cut valve 82 and the second cut valve 83 and open the simulator valve 90.

As the operation of the brake pedal 10 proceeds, a hydraulic pressure may be generated in the master cylinder 20, and the generated hydraulic pressure may be transmitted to the pedal simulator 50 through the simulator valve 90. A pedal feel may be provided to the driver due to the hydraulic pressure transmitted to the pedal simulator 50.

The controller 100 may operate the hydraulic pressure supply device 60 and the hydraulic pressure controller 70 based on a displacement of the brake pedal detected through the pedal displacement sensor 11 and pressures detected from various pressure sensors. The hydraulic pressure generated by the hydraulic pressure supply device is transmitted to the first hydraulic circuit 71 and the second hydraulic circuit 72 and then is supplied to each wheel cylinder 40, and thus a braking force is generated.

During the above braking control, when it is necessary to perform various braking operations capable of generating different braking forces to wheels, such as an anti-lock braking system (ABS) operation, a traction control system (TCS) operation, and an electronic stability control (ESC), the controller 100 may turn the inlet valve and outlet valve of the first hydraulic circuit 71 and the second hydraulic circuit 72 on or off to be closed or open or may independently control the opening degrees of the inlet valve and outlet valve of the first hydraulic circuit 71 and the second hydraulic circuit 72 using pulse width modulation (PWM) control, thereby increasing, maintaining, or decreasing the hydraulic pressure of each wheel cylinder 40.

In this way, during the braking control of the electric brake system, the controller 100 may secure a braking force by turning various electronic valves of the system on or off.

As described above, in the electric brake system, the operation of the electronic valve may be limited according to a state of a controller in operation among the plurality of controllers. That is, when the controller in operation fails, an instantaneous current drop occurs in a process of switching a current to a coil of an electronic valve in operation during a controller transition process from the malfunctioning controller to a normal controller. In this case, since the current drops to a cut-out current or less, which is a release current of the electronic valve in operation, the operation of the electronic valve is stopped, and thus normal pressure control may not be performed.

The electric brake system according to one embodiment increases the current supplied to the electronic valve in operation while a malfunctioning controller is changed to a normal controller when the controller in operation fails. Thus, even when an instantaneous current drop occurs in the electronic valve in operation, the electric brake system may secure the operating stability of the electronic valve in operation to stably secure braking performance.

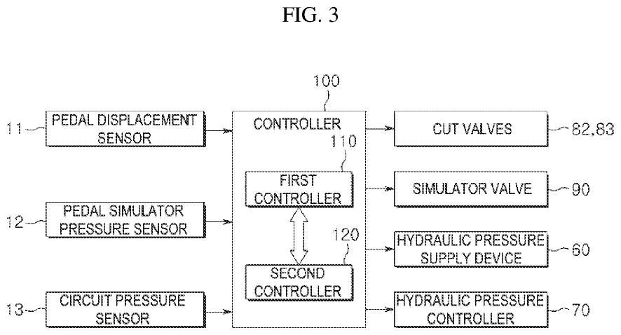

FIG. 3 is a control block diagram of the electric brake system according to one embodiment.

Referring to FIG. 3, the controller 100 performing overall control of the electric brake system is included.

The pedal displacement sensor 11, the pedal simulator pressure sensor 12, and the circuit pressure sensor 13 are electrically connected to an input side of the controller 100.

The cut valves 82 and 83, the simulator valve 90, the hydraulic pressure supply device 60, and the hydraulic pressure controller 70 are electrically connected to an output side of the controller 100.

The controller 100 may be referred to as an electronic control unit (ECU).

The controller 100 includes a first controller (a main controller) 110 and a second controller (an auxiliary controller) 120 as a pair which perform the same function in order to configure redundancy.

The first controller 110 controls the cut valves 82 and 83, the simulator valve 90, the hydraulic pressure supply device 60, and the hydraulic pressure controller 70 based on sensing information detected through the pedal displacement sensor 11, the pedal simulator pressure sensor 12, and the circuit pressure sensor 13, thereby performing braking control for generating a braking force.

The second controller 120 replaces the first controller 110 when the first controller 110 fails and continuously controls the cut valves 82 and 83, the simulator valve 90, the hydraulic pressure supply device 60, and the hydraulic pressure controller 70 based on sensing information detected through the pedal displacement sensor 11, the pedal simulator pressure sensor 12, and the circuit pressure sensor 13, thereby performing the braking control without interruption.

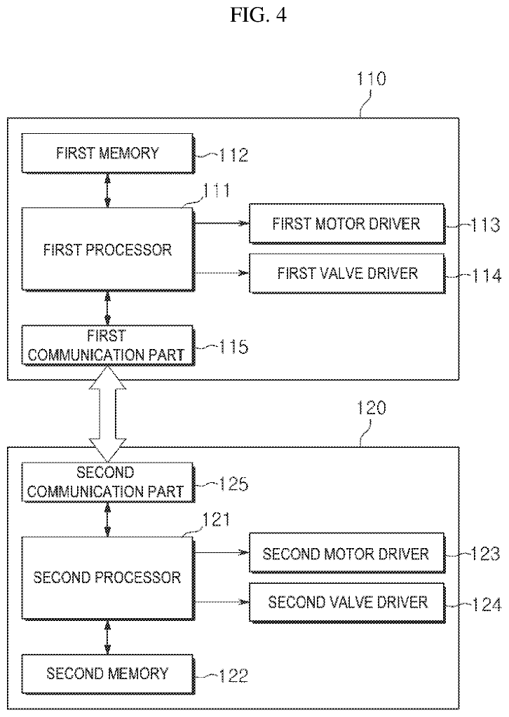

FIG. 4 is a control block diagram of a first controller and a second controller of a controller of the electric brake system according to one embodiment.

Referring to FIG. 4, the first controller 110 may include one or more first processors 111, a first memory 112, a first motor driver 113, a first valve driver 114, and a first communication part 115.

One or more processors 111 included in the first controller 100 may be integrated into one chip or may be physically separated. In addition, the first processor 111 and the first memory 112 may be implemented as a single chip.

The first processor 111 may output a motor command signal to a motor of the hydraulic pressure supply device 60, thereby driving the motor.

The first processor 111 may output valve command signals to the cut valves 82 and 83, the simulator valve 90, the inlet valve and/or outlet valve of the hydraulic pressure supply device 60, and the inlet valve and outlet valve of the hydraulic pressure controller 70, thereby opening or closing each electronic valve. The first processor 111 may output an on/off driving signal for turning each electronic valve on or off to the first valve driver 114. The first processor 111 may output a duty control signal for adjusting the opening degree of each electronic valve to the first valve driver 114.

The first memory 112 may store a program for processing or controlling the first processor 111 and various types of data for operating the electric brake system.

The first memory 112 may include volatile memories such as static random access memory (SRAM) and a dynamic RAM (DRAM) as well as non-volatile memories such as a flash memory, a read only memory (ROM) and an erasable and programmable ROM (EPROM).

Cut-in currents, cut-out currents, maximum currents, and hold currents of various electronic valves of the electric brake system may be stored in advance in the first memory 112.

The first motor driver 113 may drive the motor of the hydraulic pressure supply device 60 in response to the motor command signal of the first processor 111.

In response to the valve command signals of the first processor 111, the first valve driver 114 may drive various electronic valves of the electric brake system including the cut valves 82 and 83, the simulator valve 90, the inlet valve and/or outlet valve of the hydraulic pressure supply device 60, and the inlet valve and outlet valve of the hydraulic pressure controller 70.

The various electronic valves of the electric brake system may include solenoid type electronic valves.

For example, generally, a solenoid type electronic valve may include a sleeve coupled to an outer side of an armature, the armature installed in the sleeve and provided to be movable forward and backward, a plunger configured to move upward and downward by the forward and backward movement of the armature to open and close an orifice, an elastic member configured to pressurize the plunger toward the armature, a valve core in which the plunger and the elastic member are provided in a through-hole and which forms an internal space in a length direction, a valve seat provided in the internal space to form the orifice, and an excitation coil installed at an outer side of the sleeve and configured to move the armature forward and backward.

In the case of a normally open solenoid type electronic valve, when a current is supplied to the excitation coil, the armature is moved toward the valve core due to a magnetic force applied between the armature and the valve core, and the plunger is moved toward the valve seat to close the orifice. Since the magnetic force is released when the current is not supplied to the excitation coil, the plunger is separated from the valve seat due to elasticity of the elastic member, and thus the orifice is opened. As described above, the normally open solenoid type electronic valve may control the supply of hydraulic pressure flowing in a flow path by repeatedly closing or opening the orifice according to the forward and backward movement of the plunger.

The first communication part 115 may communicate with a second communication part 125 of the second controller 120 or transmit or receive information to or from a system installed in a vehicle through network communication. In addition, signals may be transmitted and received through a general purpose input/output (GPIO) or universal asynchronous receiver/transmitter (UART) interface directly connected between the first processor 111 and a second processor 121. Thus, even when the sensors are connected to only the first processor 111, the second processor 121 may also receive the sensing information.

The first processor 111 may drive the various electronic valves of the electric brake system through the first valve driver 114 according to the sensing information detected through the pedal displacement sensor 11, the pedal simulator pressure sensor 12, and the circuit pressure sensor 13 and a braking mode.

The second controller 120 performs the same function as the first controller 110. The second controller 120 may include one or more second processors 121, a second memory 122, a second motor driver 123, a second valve driver 124, and the second communication part 125, which perform the same functions as the components of the first controller 110.

The first controller 110 and the second controller 120 may exchange state information, such as whether a failure occurs, with each other, thereby checking states thereof in real time.

When the first controller 110, which is a main controller, fails, a controller in operation is changed from the malfunctioning first controller 110 to the normal second controller 120, and thus the normal second controller 120 drives the motor and the various valves of the electric brake system in place of the malfunctioning first controller 110. Thus, even when the first controller 110 fails, redundancy may be secured.

When the first controller 110 fails, the second controller 120 may correct a target current of an electronic valve in operation among the various electronic valves of the electric brake system and control the electronic valve to allow a current of the electronic valve in operation to reach the corrected target current.

When a failure occurs in the first controller 110 in operation during the braking control, the second controller 120 may increase the current of the electronic valve in operation to a maximum current which secures operability (cut in) within a pressure range secured by the electronic valve. Therefore, in the process of transitioning the controller 100 from the first controller 110 in operation, which fails, to the normal second controller 120, even when the current of the electronic valve in operation does not maintain a hold current and drops to a cut-out current or less and thus the electronic valve is turned off, the electronic valve is immediately re-operated to secure the operation stability of the electronic valve so that braking performance can be secured.

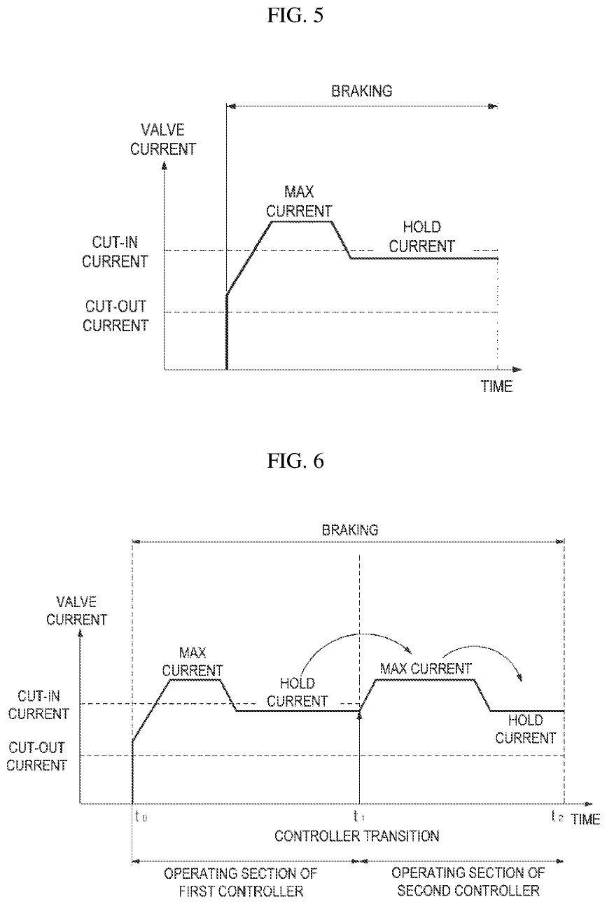

FIG. 5 is a diagram illustrating a target current pattern of an electronic valve in the electric brake system according to one embodiment.

Referring to FIG. 5, a cut-in current value, a cut-out current value, a maximum current value, and a hold current of the electronic valve of the electric brake system may be set in advance.

A cut-in current is a current for actually operating an electronic valve and may be a critical current for turning an electronic valve, which is in an off state, on.

A cut-out current is a current for actually disabling the operation of an electronic valve and may be a critical current for turning an electronic valve, which is in an on state, off.

A maximum current may be a maximum current which secures operability (cut in) within a pressure range secured by an electronic valve when the electronic valve is turned on during the braking control. The maximum current may have a current value that is greater than a value of the cut-in current as much as a preset current value.

The hold current may be a hold current for maintaining an on state of an electronic valve in operation during the braking control. The hold current may have a current value that is greater than a value of the cut-out current value and lower than the value of the maximum current.

The electronic valve may be turned on when a current supplied to the excitation coil is greater than or equal to the cut-in current and may be turned off when the current supplied to the excitation coil drops to the cut-out current. The turned-on electronic valve may maintain the on state when the current supplied to the excitation coil maintains the hold current.

In the electric brake system, in order to turn the electronic valve on during the braking control in which a hydraulic pressure is applied to both ends of the electronic valve, the supply of current to the excitation coil of the electronic valve starts first, and the supplied current value may be increased until reaching a maximum current value. When the current value reaches the maximum current value, the maximum current value may be maintained for a preset period of time and then reduced to a hold current value. In this way, the electronic valve may maintain an on state after being switched from an off state to the on state.

FIG. 6 is a diagram illustrating that a target current of the electronic valve is changed from a hold current to a maximum current and then changed to the hold current again when a malfunctioning controller is changed to a normal controller due to the failure of a controller in operation during braking control of the electric brake system according to one embodiment.

Referring to FIG. 6, when a failure occurs in the first controller 110 while the electronic valve in operation maintains the hold current during the braking control of the electric brake system, the normal second controller 120 replaces the malfunctioning first controller 110 and performs the function of the malfunctioning first controller 110. In this case, since a current drop occurs in the electronic valve in operation during the controller transition process, the current of the electronic valve in operation may not maintain the hold current and drop to the cut-out current or less, and thus the electronic valve in operation may not maintain the on state.

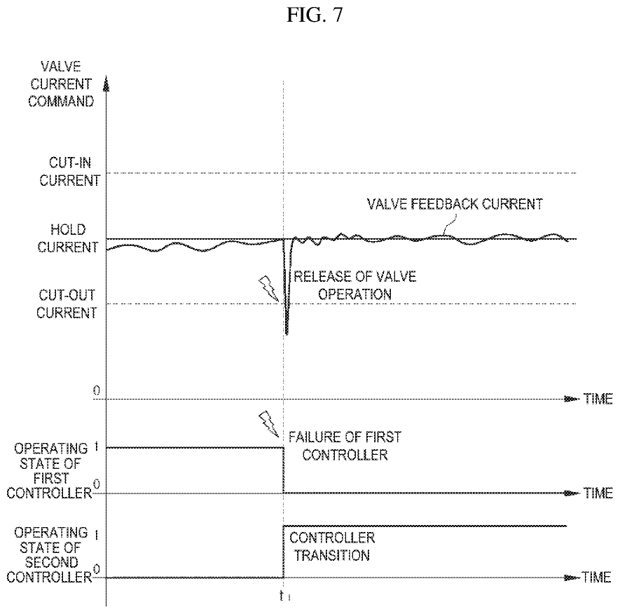

FIG. 7 is a diagram illustrating a valve operation release due to a current drop in the electronic valve occurring in a process of changing a malfunctioning first controller to a normal second controller during the braking control of the electric brake system according to one embodiment.

Referring to FIG. 7, a vertical axis denotes a valve current command, and a horizontal axis denotes time.

When a failure occurs in the first controller 110 at a time point t1 while the electronic valve in operation maintains the hold current during braking control (0 to t1), a controller transition in which the normal second controller 120 wakes up to replace the malfunctioning first controller 110 to perform the function of the malfunctioning first controller 110 occurs.

Since the supply of current to the electronic valve in operation is blocked by the malfunctioning first controller 110 and thus a current drop occurs in the electronic valve in operation during the control transition process, the current of the electronic valve in operation cannot maintain the hold current and drops to the cut-out current or less, and the electronic valve in operation cannot maintain the on state so that the operation of the electronic valve may be released.

Even when the malfunctioning first controller 110 is turned off and the normal second controller 120 is turned on at the same time and thus the normal second controller 120 supplies a hold current to the electronic valve in operation in place of the malfunctioning first controller 110, the electronic valve in operation is in a valve off state in which the operation of the electronic valve is already released so that normal pressure control may not be possible.

Referring to FIG. 6 again, when a failure occurs in the first controller 110 during the braking control, the second controller 120 may correct a target current value of the electronic valve in operation to a maximum current value that is greater than the hold current value and control the current of the electronic valve in operation to allow the current value of the electronic valve in operation to reach the maximum current value. That is, when the first controller 110 fails at the time point t1 and thus the controller transition to the second controller 120 occurs, the current value of the electronic valve may be increased from the hold current value to the maximum current value.

When the current value of the electronic valve in operation reaches the maximum current value, the second controller 120 may maintain a state in which the current value of the electronic valve reaches the maximum current value for a predetermined period of time and then reduce the current value of the electronic valve in operation again from the maximum current value to the hold current value.

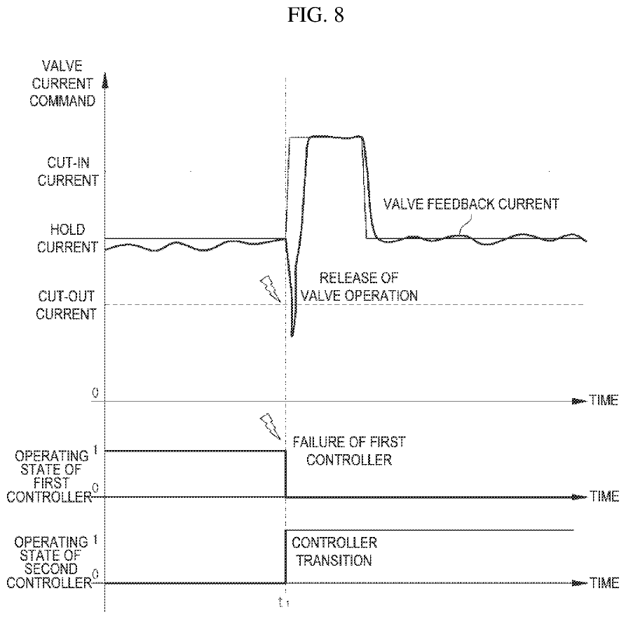

FIG. 8 is a diagram illustrating that the electronic valve is re-operated by re-applying an electronic valve current that is greater than or equal to a cut-in current in a process of changing the malfunctioning first controller to the normal second controller during the braking control of the electric brake system according to one embodiment.

Referring to FIG. 8, a vertical axis denotes a valve current command, and a horizontal axis denotes time.

When a failure occurs in the first controller 110 at a time point t1 while the electronic valve in operation maintains the hold current during braking control (0 to t1), a controller transition in which the normal second controller 120 wakes up to replace the malfunctioning first controller 110 to perform the function of the failed first controller 110 occurs.

Even when the normal second controller 120 supplies a hold current to the electronic valve in operation in place of the malfunctioning first controller 110 during the controller transition process, the electronic valve in operation is in a valve off state in which the operation of the electronic valve is already released so that normal pressure control may not be possible.

Therefore, in order to secure the operability of the electronic valve, the second controller 120 supplies a maximum current, instead of a hold current, that is greater than a cut-in current to the electronic valve in operation, thereby re-operating the electronic valve. Then, the second controller 120 reduces the current of the electronic valve from the maximum current to the hold current.

As described above, when the controller is changed due to the failure of the first controller 110 during the braking control of the electric brake system, since the electronic valve is immediately re-operated even when the current of the electronic valve in operation does not maintain the hold current and drops to the cut-out current or less due to a current drop occurring in the electronic valve in operation so that the electronic valve is turned off, the pressurization, maintenance, or depressurization performance of the electronic valve may be maintained so that the operating stability of the electronic valve can be secured.

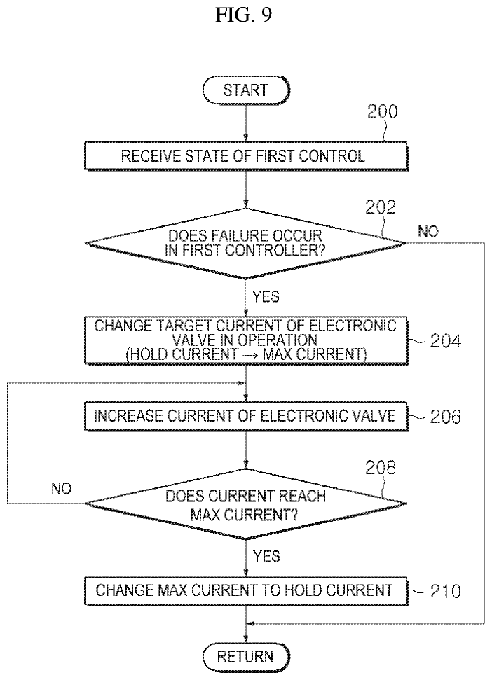

FIG. 9 is a control flowchart of an electric brake system according to one embodiment.

Referring to FIG. 9, the second controller 120 communicates with the first controller 110 in operation to receive a state of the first controller 110 in operation during the braking control of the electric brake system (200).

The second controller 120 determines whether a failure occurs in the first controller 110 according to the received state of the first controller 110 (202).

As the determination result in operation 202, when the failure occurs in the first controller 110, the second controller 120 performs the braking control of the electric brake system in place of the malfunctioning first controller 110. In this case, the second controller 120 changes a target current of an electronic valve in operation among electronic valves of the electric brake system (204). The second controller 120 may change the target current of the electronic valve in operation from a hold current to a maximum current that is greater than or equal to a cut-in current.

After the second controller 120 changes the target current of the electronic valve in operation from the hold current to the maximum current, the second controller 120 may increase the current of the electronic valve in operation to reach the changed maximum current (206).

The second controller 120 may determine whether the current of the electronic valve in operation reaches the maximum current (208).

As the determination result in operation 208, when the current of the electronic valve in operation does not reach the maximum current, the second controller 120 may return to operation 206 to perform the following operations.

On the other hand, as the determination result in operation 208, when the current of the electronic valve in operation reaches the maximum current, the second controller 120 maintains a state in which the current of the electronic valve in operation reaches the maximum current for a predetermined period of time and then reduces the current of the electronic valve in operation again from the maximum current to the hold current (210).

When the controller is changed due to the failure of the first controller 110 during the braking control of the electric brake system, since the electronic valve is immediately re-operated even when the current of the electronic valve in operation does not maintain the hold current and drops to the cut-out current or less due to a current drop occurring in the electronic valve in operation so that the electronic valve is turned off, the pressurization, maintenance, or depressurization performance of the electronic valve may be maintained so that the operating stability of the electronic valve can be secured.

As is apparent from the above description, the present disclosure can be applied equally to not only general vehicles with brake pedals and master cylinders, but also to autonomous vehicles without brake pedals and master cylinders.

In accordance with the present disclosure, braking performance can be stably secured by ensuring the operation stability of an electronic valve even when an instantaneous current drop occurs in an electronic valve in operation while a malfunctioning controller is changed to a normal controller when the controller in operation fails.

Although several embodiments of the present disclosure have been shown and described, it would be appreciated by those skilled in the art that changes may be made in these embodiments without departing from the principles and spirit of the disclosure, the scope of which is defined in the claims and their equivalents.

Exemplary embodiments of the present disclosure have been described above. In the exemplary embodiments described above, some components may be implemented as a “module”. Here, the term ‘module’ means, but is not limited to, a software and/or hardware component, such as a Field Programmable Gate Array (FPGA) or Application Specific Integrated Circuit (ASIC), which performs certain tasks. A module may advantageously be configured to reside on the addressable storage medium and configured to execute on one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. An electric brake system comprising:
a hydraulic circuit configured to guide a pressurizing medium to a wheel cylinder;
a plurality of electronic valves configured to open or close a flow path of the hydraulic circuit; and
a controller electrically connected to the plurality of electronic valves,
wherein the controller includes a first processor configured to control the plurality of electronic valves and a second processor configured to control the plurality of electronic valves based on state information received from the first processor, and
while the first processor maintains the opening or closing of at least one electronic valve among the plurality of electronic valves, the second processor is configured to provide an electrical signal to open an opened at least one electronic valve or an electrical signal to close a closed at least one electronic valve based on the state information received from the first processor.

2. The electric brake system of claim 1, wherein the second processor is configured to:
correct a target current of the at least one electronic valve based on the state information received from the first processor, and
increase a driving current supplied to the at least one electronic valve to allow the driving current of the at least one electronic valve to reach the corrected target current.

3. The electric brake system of claim 2, wherein the second processor is configured to increase the target current of the at least one electronic valve to a maximum current which secures operability within a pressure range secured by the at least one electronic valve.

4. The electric brake system of claim 3, wherein the second processor is configured to maintain the maximum current for a predetermined period of time and then reduces the maximum current to a hold current for maintaining an on state of the at least one electronic valve, based on a driving current reaching the maximum current.

5. The electric brake system of claim 2, wherein the second processor is configured to increase the target current of the at least one electronic valve to a current that is greater than a cut-in current for switching a state of the at least one electronic valve from an off state to an on state.

6. An electric brake system comprising:
a reservoir configured to store a pressurizing medium;
a hydraulic pressure supply device configured to operate a hydraulic piston by a motor and generate a hydraulic pressure of the pressurizing medium;
a hydraulic pressure controller including a plurality of electronic valves and configured to control a flow of the pressurizing medium transmitted from the hydraulic pressure supply device to a wheel cylinder; and
a controller electrically connected to the motor and the plurality of electronic valves,
wherein the controller includes a first processor configured to control the plurality of electronic valves and a second processor configured to control the plurality of electronic valves based on state information received from the first processor, and
while the first processor maintains the opening or closing of at least one electronic valve among the plurality of electronic valves, the second processor is configured to provide an electrical signal to open an opened at least one electronic valve or an electrical signal to close a closed at least one electronic valve based on the state information received from the first processor.

7. The electric brake system of claim 6, wherein the second processor is configured to:
correct a target current of the at least one electronic valve based on the state information received from the first processor, and
increase a driving current supplied to the at least one electronic valve to allow the driving current of the at least one electronic valve to reach the corrected target current.

8. The electric brake system of claim 6, wherein the second processor is configured to increase a driving current of the at least one electronic valve to a maximum current which secures operability within a pressure range secured by the at least one electronic valve.

9. The electric brake system of claim 8, wherein the second processor maintains the maximum current for a predetermined period of time and then reduces the maximum current to a hold current for maintaining an on state of the at least one electronic valve based on a driving current reaching the maximum current.

10. The electric brake system of claim 6, wherein the second processor is configured to increase a target current to a cut-in current or more, which is to switch a state of the at least one electronic valve from an off state to an on state, and then decreases the target current to a hold current for maintaining the on state of the at least one electronic valve.

11. A method of controlling an electric brake system, which includes a hydraulic circuit configured to guide a pressurizing medium to a wheel cylinder, a plurality of electronic valves configured to open or close a flow path of the hydraulic circuit, a first processor configured to control the plurality of electronic valves, and a second processor configured to control the plurality of electronic valves based on state information received from the first processor, the method comprising:
receiving, by the second processor, state information of the first processor while the first processor maintains opening or closing of at least one electromagnetic valve;
determining, by the second processor, whether a failure occurs in the first processor based on the received state information of the first processor; and
providing, by the second processor, an electrical signal to open an opened at least one electronic valve or an electrical signal to close a closed at least one electronic valve based on the failure of the first processor.

12. The method of claim 11, wherein the providing of the electrical signal comprises:
correcting, by the second processor, a target current of the at least one electronic valve; and
increasing, by the second processor, a driving current supplied to the at least one electronic valve to allow the current of the at least one electronic valve to reach the corrected target current.

13. The method of claim 11, wherein the correcting of the target current of the at least one electronic valve comprises correcting, by the second processor, the target current of the at least one electronic valve to a maximum current which secures operability within a pressure range secured by the at least one electronic valve.

14. The method of claim 13, wherein the increasing of the driving current supplied to the at least one electronic valve comprises maintaining, by the second processor, the maximum current for a predetermined period of time and then reducing the maximum current to a hold current for maintaining an on state of the at least one electronic valve based on a driving current of the at least one electronic valve reaching the maximum current.

15. The method of claim 11, wherein the correcting of the target current of the at least one electronic valve comprises correcting, by the second processor, the target current of the at least one electronic valve to a current that is greater than a cut-in current for switching a state of the at least one electronic valve from an off state to an on state.
